(19) United States
(12) Patent Application Publication
(10) Pub. No.: US 2024/0209165 A1
(43) Pub. Date: Jun. 27, 2024

(54) BREATHABLE FILM AND METHOD OF MAKING THE SAME

(71) Applicant: Berry Global, Inc., Evansville, IN (US)

(72) Inventors: Vipul S. PADMAN, Evansville, IN (US); Christopher A. SHELLEY, Evansville, IN (US)

(21) Appl. No.: 18/390,267

(22) Filed: Dec. 20, 2023

Related U.S. Application Data
(60) Provisional application No. 63/434,525, filed on Dec. 22, 2022.

(51) Int. Cl. C08J 5/18; B29C 48/00; B29C 48/08; B29C 48/21; C08K 13/02; C08L 23/06

(52) U.S. Cl. CPC C08J 5/18; B29C 48/0018; B29C 48/022; B29C 48/08; B29C 48/21; C08K 13/02; C08L 23/06; C08J 2323/06; C08J 2423/06; C08K 2003/265; C08K 2201/014; C08L 2201/08; C08L 2203/16; C08L 2205/025; C08L 2207/066; C08L 2207/20

(57) ABSTRACT

A breathable film is formed from a formulation including one or more resins and fillers. The breathable film is formed from a process including machine-direction and cross direction stretching.

### PRIORITY CLAIM

This application claims priority under 35 U.S.C. § 119(e) to U.S. Provisional Application No. 63/434,525, filed on Dec. 22, 2022, which is expressly incorporated by reference herein.

### BACKGROUND

The present disclosure relates to films, and particularly to breathable films.

### SUMMARY

According to the present disclosure, a breathable film includes one or more layers of an extruded resin.

In illustrative embodiments, the extruded resin can include a PCR resin formed from or more raw ingredients. The breathable film may be formed from a process including machine-direction and cross direction stretching. For example, an Elmendorf tear strength of the one or more layers in the cross direction may be about three times larger than the Elmendorf tear strength of the one or more layers in the machine direction; and a trapezoidal tear strength of the one or more layers in the cross direction may be about 1.9 times larger than the trapezoidal tear strength of the one or more layers in the machine direction.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a diagrammatic view showing an embodiment of an apparatus suitable for making the films of the present disclosure;

FIG. 2 is a graphical representation of a plurality of basis weights of a control film, a 100% PCR film having a first composition (PCR form 1), a 100% PCR film having a second composition (PCR form 2), and an 80% PCR film (PCR form 3);

FIG. 3 is a graphical representation of the Mocon measurements for the films of FIG. 2;

FIGS. 4A-4E are graphical representations of the machine direction (MD) tensile load at break and MD tensile elongation at break at 5%, 10%, and 25% of the films of FIG. 2;

FIGS. 5A-5E are graphical representations of the cross direction (CD) tensile load at break and CD tensile elongation at break at 5%, 10%, and 25% of the films of FIG. 2;

FIGS. 6A and 6B are graphical representations of the Elmendorf tear strength values of the notched film in the MD and CD directions for the films of FIG. 2; and

FIGS. 7A and 7B are graphical representations of the trapezoidal tear strength values of the notched film in the MD and CD directions for the films of FIG. 2.

### DETAILED DESCRIPTION

Recyclable raw materials may be used to generate a breathable film. For example, one or more raw materials may be blended together to make a breathable film. The film of the present embodiments can be made from a recycled polymer. In some embodiments, the raw materials can include post-consumer recycled (PCR) resins that can be used in the buildup of the manufacture of a breathable film. PCR resins can include a material made from recycled plastic, such as water and beverage bottles and other packaging, and offers a more sustainable source for making packaging films, containers, sheets, and many of the products that would otherwise be developed with virgin plastic resin. The film can be a monolayer film, though in some embodiments, the film can be a multi-layer film.

PCR resins used to make the films of the present embodiments result in films having unique and/or unexpected properties. For example, recycled materials can contain foreign particulates and/or impurities that can contaminate the film, thereby making it unusable for its intended purpose. Some recycled materials are not used to make quality breathable films, and a person having ordinary skill in the art would recognize that minimizing an amount of the PCR resin in the film typically yields superior results. Unexpectedly, the film of the present embodiments can have a high content, e.g., wt % of PCR resin. For example, in some embodiments, the PCR resin content of the present films can be about 80% PCR and/or about 100% PCR.

A resin used to make the film of the present embodiments can include an ethylene-based resin. Representative ethylene-based resins that may be used in accordance with the present disclosure include but are not limited to low density polyethylene (LDPE), high density polyethylene (HDPE), linear low density polyethylene (LLDPE), metallocene polyethylene (mPE), very low density polyethylene (VLDPE), ultra-low density polyethylene (ULDPE), polypropylene, ethylene-propylene copolymers, polymers made using a single-site catalyst, ethylene maleic anhydride copolymers (EMAs), ethylene vinyl acetate copolymers (EVAs), polymers made using Zeigler-Natta catalysts, styrene-containing block copolymers, and/or the like, and combinations thereof.

Methods for manufacturing polyolefins are described in The Wiley Encyclopedia of Packaging Technology (Aaron L. Brody et al. eds., 2nd Ed. 1997), which is incorporated by reference herein in its entirety, except that in the event of any inconsistent disclosure or definition from the present specification, the disclosure or definition herein shall be deemed to prevail. The density of a polyethylene may be achieved by copolymerizing ethylene with a sufficient amount of one or more monomers. In illustrative embodiments, the monomers are selected from 1-butene, 1-hexene, 4-methyl-1-pentene, 1-octene, and combinations thereof. Methods for manufacturing polypropylene are described in Kirk-Othmer Concise Encyclopedia of Chemical Technology, pp. 1420-1421 (Jacqueline I. Kroschwitz et al. eds., 4th Ed. 1999), which is incorporated herein by reference, except that in the event of any inconsistent disclosure or definition from the present specification, the disclosure or definition herein shall be deemed to prevail.

In illustrative embodiments, the ethylene-based resin for use in accordance with the present disclosure includes polyethylene. In some embodiments, the polyethylene may be a long chain branching polyethylene, such as a long chain branching LDPE. The polyethylene can be a homopolymer or a copolymer.

When the ethylene-based resin used to make one or more layers includes LDPE, that layer may comprise about 1 wt % LDPE to about 99 wt % LDPE, about 10 wt % LDPE to about 90 wt % LDPE, about 20 wt % LDPE to about 90 wt % LDPE, about 30 wt % LDPE to about 90 wt % LDPE, about 40 wt % LDPE to about 90 wt % LDPE, about 50 wt % LDPE to about 90 wt % LDPE, about 60 wt % LDPE to about 90 wt % LDPE, about 70 wt % LDPE to about 90 wt % LDPE, about 80 wt % LDPE to about 90 wt % LDPE, about 10 wt % LDPE to about 80 wt % LDPE, about 20 wt % LDPE to about 80 wt % LDPE, about 30 wt % LDPE to about 80 wt % LDPE, about 40 wt % LDPE to about 80 wt % LDPE, about 50 wt % LDPE to about 80 wt % LDPE, about 60 wt % LDPE to about 80 wt % LDPE, about 70 wt % LDPE to about 80 wt % LDPE, about 10 wt % LDPE to about 70 wt % LDPE, about 20 wt % LDPE to about 70 wt % LDPE, about 30 wt % LDPE to about 70 wt % LDPE, about 40 wt % LDPE to about 70 wt % LDPE, about 50 wt % LDPE to about 70 wt % LDPE, about 60 wt % LDPE to about 70 wt % LDPE, about 10 wt % LDPE to about 60 wt % LDPE, about 20 wt % LDPE to about 60 wt % LDPE, about 30 wt % LDPE to about 60 wt % LDPE, about 40 wt % LDPE to about 60 wt % LDPE, about 50 wt % LDPE to about 60 wt % LDPE, about 10 wt % LDPE to about 50 wt % LDPE, about 20 wt % LDPE to about 50 wt % LDPE, about 30 wt % LDPE to about 50 wt % LDPE, about 40 wt % LDPE to about 50 wt % LDPE, about 10 wt % LDPE to about 40 wt % LDPE, about 20 wt % LDPE to about 40 wt % LDPE, about 30 wt % LDPE to about 40 wt % LDPE, about 10 wt % LDPE to about 30 wt % LDPE, about 20 wt % LDPE to about 30 wt % LDPE, or about 10 wt % LDPE to about 20 wt % LDPE. In some embodiments, the layer comprises less than about 50% or less than about 40% LDPE. In some embodiments, the layer comprises at least about 60% or at least about 70% LDPE. In some embodiments the LDPE can include Dow 640.

When the ethylene-based resin used to make one or more layers includes HDPE, that layer may comprise about 1 wt % HDPE to about 99 wt % HDPE, about 10 wt % HDPE to about 90 wt % HDPE, about 20 wt % HDPE to about 90 wt % HDPE, about 30 wt % HDPE to about 90 wt % HDPE, about 40 wt % HDPE to about 90 wt % HDPE, about 50 wt % HDPE to about 90 wt % HDPE, about 60 wt % HDPE to about 90 wt % HDPE, about 70 wt % HDPE to about 90 wt % HDPE, about 80 wt % HDPE to about 90 wt % HDPE, about 10 wt % HDPE to about 80 wt % HDPE, about 20 wt % HDPE to about 80 wt % HDPE, about 30 wt % HDPE to about 80 wt % HDPE, about 40 wt % HDPE to about 80 wt % HDPE, about 50 wt % HDPE to about 80 wt % HDPE, about 60 wt % HDPE to about 80 wt % HDPE, about 70 wt % HDPE to about 80 wt % HDPE, about 10 wt % HDPE to about 70 wt % HDPE, about 20 wt % HDPE to about 70 wt % HDPE, about 30 wt % HDPE to about 70 wt % HDPE, about 40 wt % HDPE to about 70 wt % HDPE, about 50 wt % HDPE to about 70 wt % HDPE, about 60 wt % HDPE to about 70 wt % HDPE, about 10 wt % HDPE to about 60 wt % HDPE, about 20 wt % HDPE to about 60 wt % HDPE, about 30 wt % HDPE to about 60 wt % HDPE, about 40 wt % HDPE to about 60 wt % HDPE, about 50 wt % HDPE to about 60 wt % HDPE, about 10 wt % HDPE to about 50 wt % HDPE, about 20 wt % HDPE to about 50 wt % HDPE, about 30 wt % HDPE to about 50 wt % HDPE, about 40 wt % HDPE to about 50 wt % HDPE, about 10 wt % HDPE to about 40 wt % HDPE, about 20 wt % HDPE to about 40 wt % HDPE, about 30 wt % HDPE to about 40 wt % HDPE, about 10 wt % HDPE to about 30 wt % HDPE, about 20 wt % HDPE to about 30 wt % HDPE, or about 10 wt % HDPE to about 20 wt % HDPE. In some embodiments, the layer comprises less than about 40% or less than about 35% HDPE. In some embodiments, the layer comprises at least about 30% or at least about 35% HDPE. In some embodiments the LDPE can include Dow 8007.

When the ethylene-based resin used to make one or more layers includes LLDPE, that layer may comprise about 1 wt % LLDPE to about 99 wt % LLDPE, about 10 wt % LLDPE to about 90 wt % LLDPE, about 20 wt % LLDPE to about 90 wt % LLDPE, about 30 wt % LLDPE to about 90 wt % LLDPE, about 40 wt % LLDPE to about 90 wt % LLDPE, about 50 wt % LLDPE to about 90 wt % LLDPE, about 60 wt % LLDPE to about 90 wt % LLDPE, about 70 wt % LLDPE to about 90 wt % LLDPE, about 80 wt % LLDPE to about 90 wt % LLDPE, about 10 wt % LLDPE to about 80 wt % LLDPE, about 20 wt % LLDPE to about 80 wt % LLDPE, about 30 wt % LLDPE to about 80 wt % LLDPE, about 40 wt % LLDPE to about 80 wt % LLDPE, about 50 wt % LLDPE to about 80 wt % LLDPE, about 60 wt % LLDPE to about 80 wt % LLDPE, about 70 wt % LLDPE to about 80 wt % LLDPE, about 10 wt % LLDPE to about 70 wt % LLDPE, about 20 wt % LLDPE to about 70 wt % LLDPE, about 30 wt % LLDPE to about 70 wt % LLDPE, about 40 wt % LLDPE to about 70 wt % LLDPE, about 50 wt % LLDPE to about 70 wt % LLDPE, about 60 wt % LLDPE to about 70 wt % LLDPE, about 10 wt % LLDPE to about 60 wt % LLDPE, about 20 wt % LLDPE to about 60 wt % LLDPE, about 30 wt % LLDPE to about 60 wt % LLDPE, about 40 wt % LLDPE to about 60 wt % LLDPE, about 50 wt % LLDPE to about 60 wt % LLDPE, about 10 wt % LLDPE to about 50 wt % LLDPE, about 20 wt % LLDPE to about 50 wt % LLDPE, about 30 wt % LLDPE to about 50 wt % LLDPE, about 40 wt % LLDPE to about 50 wt % LLDPE, about 10 wt % LLDPE to about 40 wt % LLDPE, about 20 wt % LLDPE to about 40 wt % LLDPE, about 30 wt % LLDPE to about 40 wt % LLDPE, about 10 wt % LLDPE to about 30 wt % LLDPE, about 20 wt % LLDPE to about 30 wt % LLDPE, or about 10 wt % LLDPE to about 20 wt % LLDPE. In some embodiments, the layer comprises less than about 40% or less than about 35% LLDPE. In some embodiments, the layer comprises at least about 10% or at least about 20% LLDPE. In some embodiments the LLDPE can include EM 3518.

In some embodiments, the ethylene-based resin includes a layer comprising a blend of polymers. In illustrative embodiments, such a layer can include a blend of at least two or at least three polymers. In some embodiments, a layer can include a blend of at least two or at least three polyolefins. In some embodiments, a layer can include a blend of at least two or at least three polyethylenes.

An exemplary resin can include a linear low-density polyethylene (LLDPE) Repro grade resin, e.g., EM 3518 or Ecowise (PCR Ecowise LLDPE). The feedstock for these resins can include recycled materials from grocery stores, supermarkets, warehouses, distribution centers and the like. An amount of the PCR Ecowise LLDPE in the formulation of the film of the present embodiments can be approximately in a range from about 10 wt % to about 20 wt % and/or approximately in a range from about 10 wt % to about 15 wt %. A person of ordinary skill in the art would expect an end application of the films made from this resin may include plastic bags, which gauge range from 0.6 mil to 2 mil, or solid plastic, plastic-wood decking, and floor applications.

Another exemplary resin can include a KWR105M2KW HDPE grade from KW Plastics. The feedstock for these resins can come from bulky rigids, which includes waste carts, pails, crates, bins, and so forth. A person of ordinary skill in the art would expect an end application may include injection molded products. In some embodiments, increasing an amount of HDPE can increase an overall density of the film.

Various properties of the above-listed resins and their ingredients may be found in Technical Data Sheets that correspond to each compound, the Technical Data Sheets being publicly available information as recognized by one skilled in the art and the contents thereof being incorporated herein by reference in their entireties.

An amount of PCR resin used to make the film of the present embodiments can vary. For example, in some embodiments, the film can be made with about 80% post-consumer recycled resin. Alternatively, in some embodiments, the film can be made with about 100% post-consumer recycled resin. As mentioned above, in some embodiments, performance of a PCR resin in formation of films can be less favorable than virgin plastic resin due to one or more factors. For example, the PCR resin can undergo degradation, which can produce a film that degrades more quickly. After each recycling process, polymer chains can undergo degradation resulting in chain scission, e.g., breaking of a large polymer chain into smaller chains, which can result in poor mechanical properties. Moreover, polymer chains can undergo crosslinking after recycling, which causes several chains to react with others producing a gel-like network that can also result in the loss of mechanical properties. Additionally, for cross-linked polymer chains, the gels can pose processing challenges as they can form holes or adversely affect the aesthetic of a finished product.

PCR resins can also be contaminated which can lead to poorer performance in films. For example, PCR resins can experience cross-contamination with other polymers with the incompatibility between the recycled polymers leading to formation of materials with poor properties. In some embodiments, the PCR resins can be contaminated with one or more foreign objects, e.g., glue, paper, wood, and so forth. A person skilled in the art will recognize that the presence of a foreign contaminant can also reduce one or more desirable properties of the PCR resin and/or make the PCR resin unusable for film formation.

As noted above, unexpectedly, the films of the present embodiments can outperform virgin resins despite their high PCR resin content, e.g., 80% PCR resin and/or 100% PCR resin films. It is believed, without being limited by this theory, that this outperformance can be attributed to the blend of polymers of different molecular weights used in the present resins. For example, the blend of polymers used herein can impart superior toughness properties to the resins, which result in superior breathability, Elmendorf tear strength, trapezoidal tear strength, and mocon values. The details and measurements of the present resins are discussed in greater detail below.

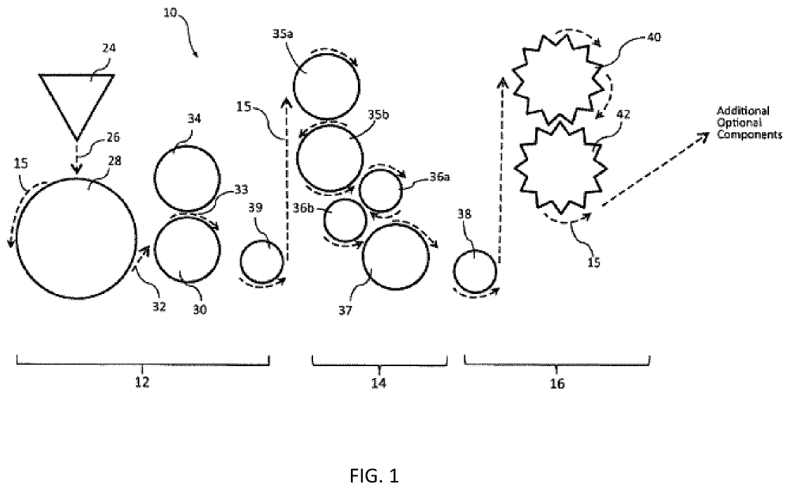

A film forming apparatus 10 that is suitable for forming the presently disclosed films is shown, for example, in FIG. 1. Machine direction, as applied to a film or nonwoven material, means the direction that is parallel to the direction of travel of the film or nonwoven as it is processed in the film forming apparatus. The cross direction, also referred to as transverse direction, means the direction perpendicular to the machine direction. In one non-limiting embodiment, and as depicted in FIG. 1, film forming apparatus 10 comprises a casting/drawing section 12, a machine direction orientation (MDO) section 14, and a cross direction interdigitated roller (CDI) section 16. Optionally, film forming apparatus 10 may comprise additional suitable sections, such as an annealer section, a winder, an additional machine direction orientation section, and/or a corona treatment section. In other embodiments, the order of the sections or components thereof may differ than those depicted in FIG. 1.

The casting/drawing section 12 comprises an extruder 24 followed by at least one chill roller 28 with a first gap 26 therebetween. The position of extruder 24 relative to chill roller 28 may vary from that shown in FIG. 1 to a position slightly more downstream from that shown, yet in which the extruder 24 is still in a position to deposit a melt curtain comprising the extrudate onto the chill roller 28. Downstream of the chill roller 28 is a stretching roller 30 which is separated from the stretching roller 30 by a second gap 32. In operation, the extruder 24 melts and extrudes an extrudate across gap 26 onto chill roller 28, forming a web, or film, 15. Film 15 travels across second gap 32 into the nip 33 formed between slave roller 34 and stretching roller 30. The film 15 then passes over an idle roller 39 to the machine direction orientation section 14.

The webs, or films, of the present embodiments may be formed by a variety of suitable means, and may be cast, blown, calendered, mono-extruded, co-extruded, chill cast, nip embossed, or any other suitable method which would result in a film compatible with the process described herein.

In one embodiment, the thermoplastic polymeric film formulation may be blended in the extruder 24, for example at a temperature of from about 210° C. to about 280° C. The exact temperature will depend upon the formulation of the polymeric compositions. The web, or melt curtain, comprising the polymeric composition may be extruded (or coextruded if a multilayer film is being formed) onto the chill roller 28. The film 15, as it leaves the chill roller 28, can be stretched to the desired thickness without significant MD molecular orientation. In some embodiments, at least two chill rollers can be present, with the speeds and temperatures of the chill rollers each may be the same or different, but will be sufficient for the film to be stretched to the desired thickness without significant MD molecular orientation, yet below the melting temperature of the polymeric composition. By way of non-limiting example only, the temperatures may differ by 5° C., by 10° C., or more. The chill rollers may each individually be smooth, textured, coated (e.g., with a release treatment), which may be the same or different on each roll.

The length of first gap 26 between the extruder 24 and chill roller 28 may be the shortest distance between the extruder 24 and the chill roller 28, and may be greater than previous cast MDO processes. In one embodiment, the length of the first gap 26 is greater than 2.5 cm, alternatively is from about 2.5 cm to about 25 cm, alternatively is from about 3 cm to about 15 cm, and alternatively is from about 3 cm to about 7.6 cm. The extrudate may undergo a melt curtain stretch, with a corresponding reduction in thickness, in gap 26 of from 10 times to about 25 times (about 10× to about 25×).

In one embodiment, the apparatus may include an additional roller and a nip between the extruder 24 and the chill roller 28, as depicted in U.S. Pat. No. 7,442,332. In another embodiment, the apparatus may include one or more additional chill rollers. In yet another embodiment, chill roller 28 may be replaced by two rollers, wherein the rollers form an additional nip. The rollers may be a metal roller and a rubber roller, and the metal roller optionally may be embossed. After passing through the additional nip, the film is advanced through nip 33 and further through the process described herein.

The length of the second gap 32 between the chill roller 28 and the nip 33 at the stretching roller 30 is the shortest distance between the chill roller 28 and the stretching roller 30, and in one embodiment is at least about 7.5 cm, alternatively is from about 7.5 to about 30 cm, alternatively is from about 7.5 to about 20 cm, alternatively is from about 7.5 cm to about 10 cm, alternatively is about 30 cm, alternatively is about 20 cm, alternatively is about 15 cm, alternatively is about 15 cm, and alternatively is less than 10 cm. The film 15, after being stretched between chill roller 28 and stretching roller 30, is essentially a nonporous film having limited molecular orientation in the MD.

Herein, “imparting limited machine direction orientation to the film” means to produce sufficient MD orientation to give the film an MD load at break of at least 2.0 N/cm with a CD load at break of at least 0.7 N/cm. In addition, the film will have a ratio of MD load at break to CD load at break of from about 1 to about 15. Although the amount of MDO may not be directly quantifiable, the amount of MDO correlates to the properties of the film. A film that has limited MDO will have, in particular, improved CD properties, such as CD Elmendorf and Trapezoidal tear strength, CD tensile strength at break, and an improved balance of CD and MD tensile strengths relative to previously described films.

Downstream from casting/drawing section 12, the film 15 may pass from stretching roller 30 around idle roller 39 to a first machine direction orientation (MDO) section 14. The purpose of this section is to further stretch the film in the machine direction while still avoiding significant MD orientation.

As would be understood by one of skill in the art, the number of stretching rollers, heated rollers and chill rollers within first MDO section 14 may vary, as well as the number of MDO sections. Thus, in an alternative embodiment, the apparatus may comprise one or more additional sets of stretching rollers, heated rollers, and/or cooling rollers to impart desired physical and aesthetic characteristics, such as porosity and opacity. By way of example, a second set of heated rollers, stretching rollers and/or cooling roller may be located in first MDO section 14, downstream from stretching rollers 36a and 36b and upstream from cooling roller 37. In an alternative embodiment, a second set of heated rollers, stretching rollers and/or cooling roller are located downstream from CDI section 16 in a second MDO section.

Cross direction interdigitated roller (CDI) section 16, if present, may include a tensioning roller 38 followed by interdigitating rollers 40, 42. In the present embodiments, interdigitating rollers 40, 42 are designed to stretch the film in the cross direction, resulting in additional film activation and imparting breathability. In one embodiment, machine direction interdigitating rollers are used in place in of, or in addition to, cross direction interdigitating rollers 40, 42, either before or after CDI section 16. Suitable cross direction interdigitated rollers are described in U.S. Pat. No. 7,442,332.

In place of MDO section and or CDI section or in addition to these sections, the film can be stretched using a tentering frame (not shown). This can be used to effect both MDO and CDO.

The film 15 may move from the CDI section 16 to other optional components, including but not limited to, a corona treatment section, an annealing section, a second MDO section and/or a winder, where it is then ready for its intended use. The films and/or laminates of the present disclosure are suitable for use as pouches for packaging, wrapping products such as personal hygiene items, as well as foods such as sandwiches, fruits, vegetables and the like, breathable poly bags such as breathable diaper poly bags. In the case of personal hygiene products, the present films can be used in disposable absorbent products. Some further non-limiting examples include diapers, training pants, adult incontinence pads and pants, swimwear, sanitary napkins, tampons, panty liners, etc. In one embodiment, the films can be related to an absorbent article comprising the films described herein. In one embodiment, the absorbent article is a diaper.

The present disclosure further describes laminates comprising the films of the present embodiments. The laminates comprise a first layer comprising the breathable, thermoplastic films described herein, and a substrate attached to one or both surfaces of the film. The substrate may be any woven or a nonwoven material suitable for use with thermoplastic films, and in one embodiment is a spunbond nonwoven. The substrate may have a basis weight of 100 gsm or less, alternatively 50 gsm or less, alternatively 25 gsm or less, alternatively 20 gsm or less, alternatively 15 gsm or less, and alternatively 10 gsm or less. In some embodiments, the substrate may have a basis weight approximately in a range of about 10 gsm to about 20 gsm, approximately in a range of about 12 gsm to about 18 gsm, and/or approximately in a range of about 13 gsm to about 15 gsm. The substrate may be attached to the film by a variety of means such as adhesive lamination, ultrasonic bonding, extrusion bonding, etc.

The importance of some testing values can vary based on the use application. For example, in embodiments in which the films and/or laminates of the present disclosure are used in items such as diapers, the present films and/or laminates can be used in diaper backsheets or ears (closure tabs). In such embodiments, machine calculations can be performed to evaluate how much stretching is experienced by the film, e.g., determining the load at each point. Specifically, stretching in the cross-direction (CD) and machine direction (MD) can be evaluated, with superior stretching in the CD being preferred as the closure tabs of diapers are routinely stretched in the cross-direction as opposed to the MD during use. It will be appreciated however that for alternate applications, MD stretching performance can be preferred when the use of the films and/or laminates is routinely stretched in the MD.

Additional measurements taken to evaluate performance of the films and/or laminates can include mass at break, e.g., the load taken to break the film and/or laminate, Elmendorf tear strength, and trapezoidal tear strength. Tear strength or tear force, reflects the ease or difficulty by which the film can be torn, and is expressed in units of grams. Herein, tear strength may be measured by the Elmendorf notched tear test, ASTM D-1922, incorporated herein by reference and/or by the trapezoidal tear test (trap test), as described herein or according to ASTM D-5587. The test may be performed with either a notched or an unnotched film and in either the CD or MD direction. Unless otherwise specified, herein tear strength is notched tear strength. It is noted that tear strength is related to film thickness, and any comparison of tear strengths must take into account the relative basis weights of the comparative samples.

The films of the present embodiments can have an Elmendorf tear strength in the machine direction of at least about 5 g, alternatively of at least about 10 g, alternatively of at least about 15 g, alternatively of at least about 25 g, alternatively of at least about 50 g, alternatively from about 5 g to about 50 g, alternatively from about 10 g to about 45 g, and alternatively from about 15 g to about 40 g. The films of the present embodiments can have an Elmendorf tear strength in the cross direction of at least about 25 g, alternatively of at least about 50 g, alternatively of at least about 75 g, alternatively of at least about 150 g, alternatively of at least about 250 g, alternatively from about 25 g to about 250 g, alternatively from about 50 g to about 200 g, and alternatively from about 100 g to about 175 g. In some embodiments, the Elmendorf tear strength of the breathable film in the cross direction can be about three times larger than the Elmendorf tear strength of the one or more layers in the machine direction, as discussed below.

The films of the present embodiments can have a trapezoidal (“trap”) tear strength in the machine direction of at least about 200 g, alternatively of at least about 300 g, alternatively of at least about 350 g, alternatively of at least about 400 g, alternatively of at least about 500 g, alternatively of at least about 750 g, alternatively of at least about 100 g, alternatively from about 200 g to about 1000 g, alternatively from about 250 g to about 750 g, and alternatively from about 300 g to about 600 g. The films of the present embodiments can have a trap tear strength in the cross direction of at least about 300 g, alternatively of at least about 400 g, alternatively of at least about 500 g, alternatively of at least about 600 g, alternatively of at least about 800 g, alternatively from about 300 g to about 800 g, alternatively from about 400 g to about 750 g, and alternatively from about 500 g to about 600 g. In some embodiments, the trapezoidal tear strength of the breathable film in the cross direction can be about 1.9 times larger than the trapezoidal tear strength of the one or more layers in the machine direction, and/or the trapezoidal tear strength of the breathable film in the cross direction can be about two times larger than the trapezoidal tear strength of the one or more layers in the machine direction, as discussed below.

The present embodiments will be further appreciated in light of the following detailed examples.

### EXAMPLES

The following examples are set forth for purposes of illustration only. Parts and percentages appearing in such examples are approximate unless otherwise stipulated.

A number of films were formed according to the previously described method. The polymeric formulation of the PCR resins in the film of the present embodiments may include a combination of one or more raw ingredients. In exemplary embodiments, the formulation may include CF7030PE=70% FL 500 CaCO₃, 29.85% EM 3518 LLDPE and 0.15% anti-oxidant package; HC950PE=72% FL 500 CaCO₃, 21.85% Dow 2036.01G LLDPE, 6% TiO₂ and 0.15% anti-oxidant package; and PCR Compound=70% FL 500 CaCO₃, 29.8% Ecowise LLDPE and 0.2% anti-oxidant package, which are present in the percentages presented in Table 1, reproduced below:

TABLE 1

| | | PCR | PCR | PCR |
|---|---|---|---|---|
| Material | Control | form 1 | form 2 | form 3 |
| CF7030PE compound | 60 | | | |
| HC950PE | | | | 50 |
| PCR Compound | | 60 | 60 | |
| EM3518 | 5 | | | |
| PCR Ecowise LLDPE | | 20 | 10 | 20 |
| Dow 8007 | 30 | | | |
| PCR KWR105M2KW | | 20 | 30 | 30 |
| HDPE | | | | |
| Dow 640 | 5 | | | |
| Total | 100 | 100 | 100 | 100 |
| Total Fillers | 42 | 42 | 42 | 39 |
| Total Polymer Phase | 58 | 58 | 58 | 61 |
| Total PCR Phase | 0 | 58 | 58 | 50 |
| Total PCR in the | 0.0 | 100.0 | 100.0 | 82.0 |
| Polymer Phase (%) | | | | |

Formation of the films of the present embodiments can occur by combining one or more of the raw ingredients discussed above. For example, the CF7030PE can be compounded to create the resin of the present embodiments and/or outsourced to a third party supplier. Once this resin is compounded, the compounded resins can be placed into an extruder and passed to the hopper for extrusion on a lab line. In some embodiments, the breathable film can be manufactured in two steps. First, the raw ingredients discussed above can be extruded on Killion manufacturing line to make precursor films. The extruder can be run at different line speeds to change the basis weight of the films. Once the films are formed, the films can be put in the CDI unit to stretch the film in the CD direction to create breathability. The remaining raw ingredients can be added to the film formation via the techniques discussed above. As noted above, various properties of the above-listed ingredients may be found in Technical Data Sheets that correspond to each compound, with the Technical Data Sheets being publicly available information as recognized by one skilled in the art and the contents thereof being incorporated herein by reference in their entireties.

Table 1 illustrates exemplary formulations of a control film (control) compared to films manufactured with 100% PCR resin (PCR form 1, PCR form 2), and 80% PCR resin (PCR form 3). The LLDPE (EM3518), the HDPE (DOW 8007), and the LDPE (DOW 640), which are discussed above are also presented in the presented percentages. It will be appreciated that the percentages are presented in terms of weight percent where a total weight of the film is 100 wt %.

The 100% PCR resin films can include a total filler of 42 wt % and a total polymer phase of 58 wt %, in which the total PCR resin phase is 58 wt %, which accounts for a total PCR in the polymer phase of 100% in the 100% PCR resin film. The control film has a total PCR in the polymer phase of 0% and the 80% PCR resin film has a total PCR in the polymer phase of approximately 82%.

As shown, the control film can include EM 3518 as the LLDPE, which is omitted from the 100% PCR resin and the 80% PCR resin films, with these films containing PCR Ecowise LLDPE. The difference in formulations can occur due to PCR Ecowise LLDPE having a density of less than 0.92, which resulted in EM 3518 being used in making control film.

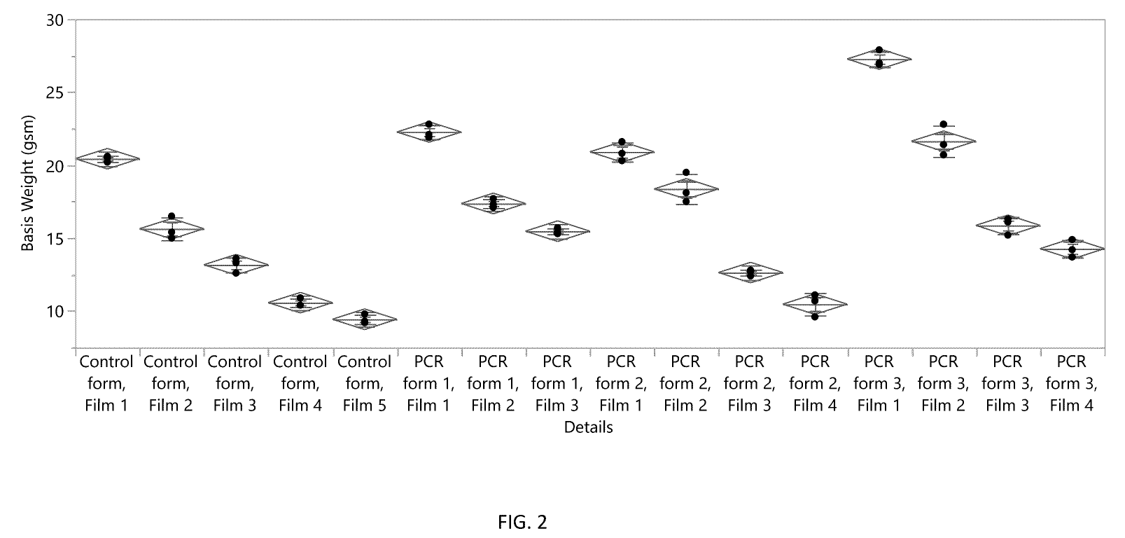

FIG. 2 illustrates the basis weights of the control film, as well as the 100% PCR films (PCR form 1, PCR form 2), and the 80% PCR film (PCR form 3) that were tested using the above-described methods. As shown, the basis weights of the control film approximately ranged from about 20 gsm to about 5 gsm, the basis weights of the 100% PCR film having 20 wt % PCR Ecowise LLDPE and 20 wt % PCR KWR105M2KW HDPE ranged from about 25 gsm to about 15 gsm, the basis weights of the 100% PCR film having 10 wt % PCR Ecowise LLDPE and 30 wt % PCR KWR105M2KW HDPE ranged from about 20 gsm to about 5 gsm, and the basis weights of the 80% PCR film approximately ranged from about 30 gsm to about 15 gsm. While testing was performed across three basis weights of PCR form 1, four basis weights of PCR form 2, four basis weights of PCR form 3, and five basis weights of the control, it will be appreciated that any number of data points can be tested for each of the films.

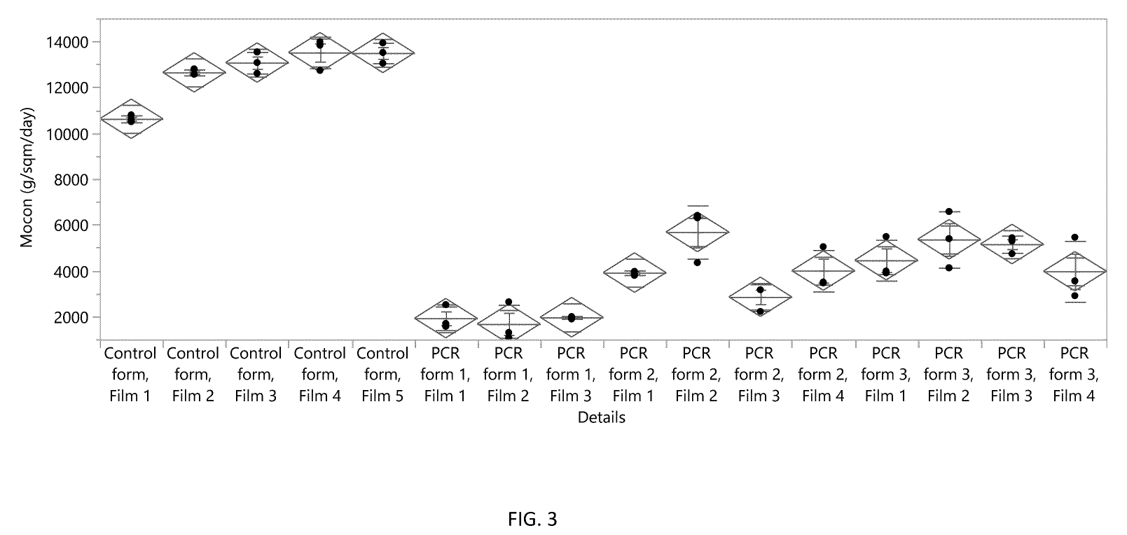

FIG. 3 illustrates the mocon, or film permeation testing, results of the above-described films. Mocon testing can include measurement of moisture vapor transmissibility rate, e.g., an amount of moisture in grams that is moved through the film in a given period. The given period can vary. For example while FIG. 3 shows the time measurement in the embodiments of the present testing including a day, other embodiments of the given period can include an hour, half of a day, a week, and/or a month. Mocon values above about 500 g/m²/day can correlate to breathable films, with ranges for breathable films that allow air to pass through while maintaining a barrier of protection being in approximately a range of about 1,000 g/m²/day to about 2,000 g/m²/day. As shown, the Mocon testing for the control films resulted in values greater than 10,000 g/m²/day while PCR form 1, PCR form 2, and PCR form 3 across all basis weights showed Mocon values of about 1,000 g/m²/day to about 20,000 g/m²/day, about 1,000 g/m²/day to about 15,000 g/m²/day, and/or about 1,000 g/m²/day to about 6,000 g/m²/day. From these results, the PCR form 1 film of the present embodiments (100% PCR film having 20 wt % PCR Ecowise LLDPE) yields a film having Mocon values in the desired range.

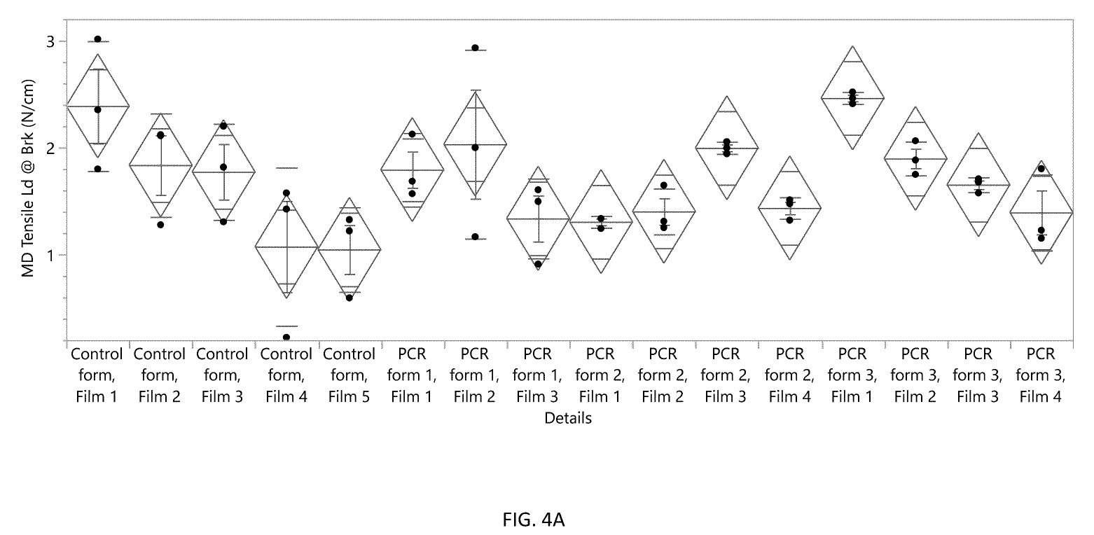

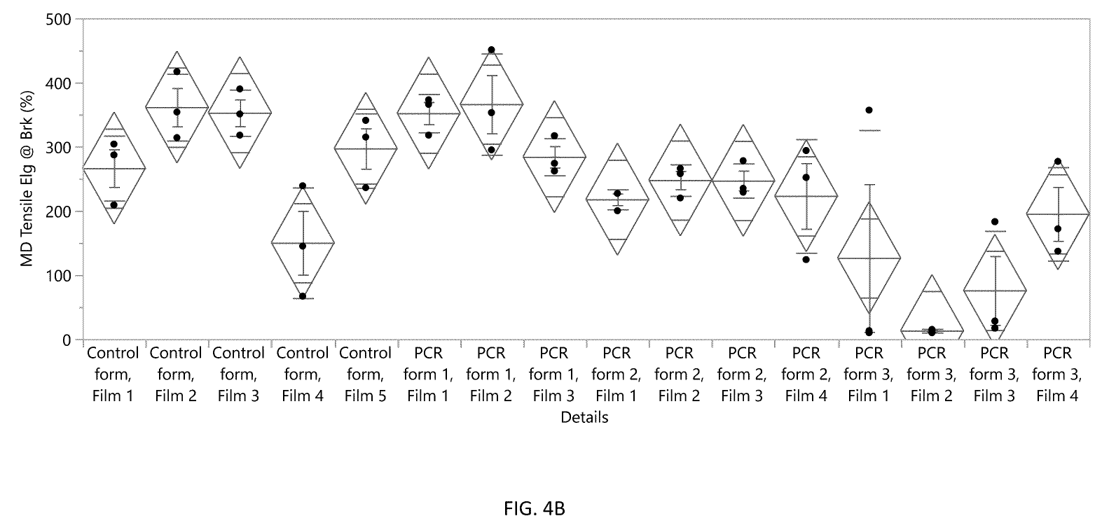

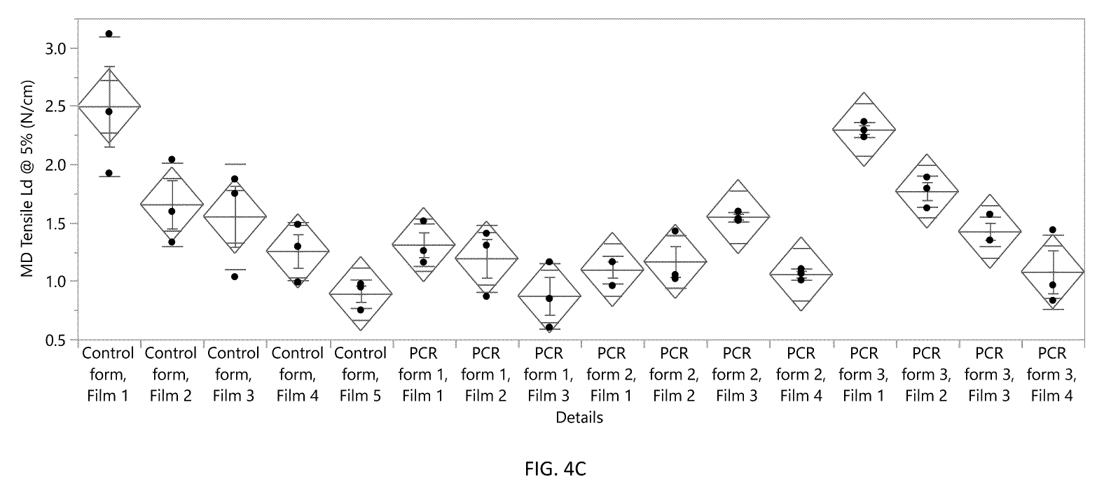

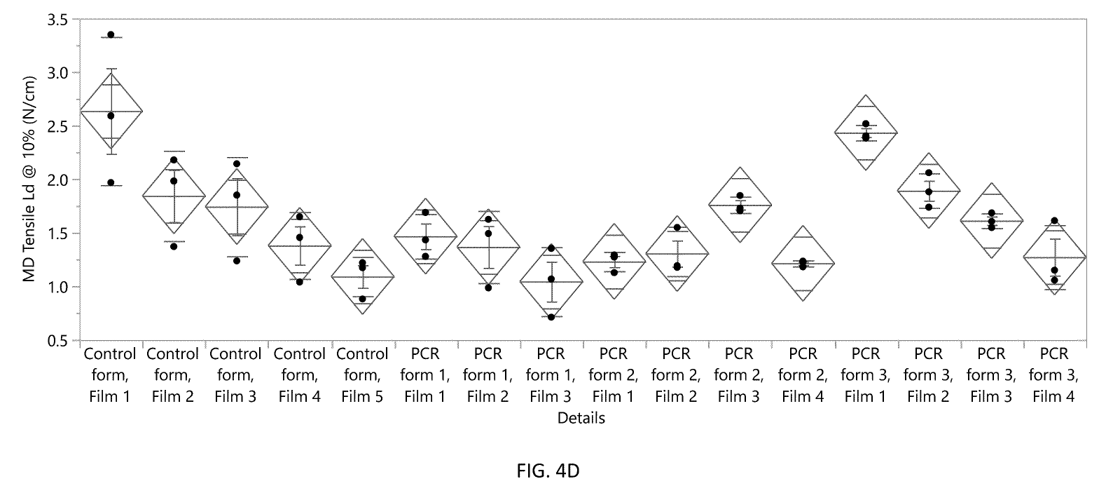

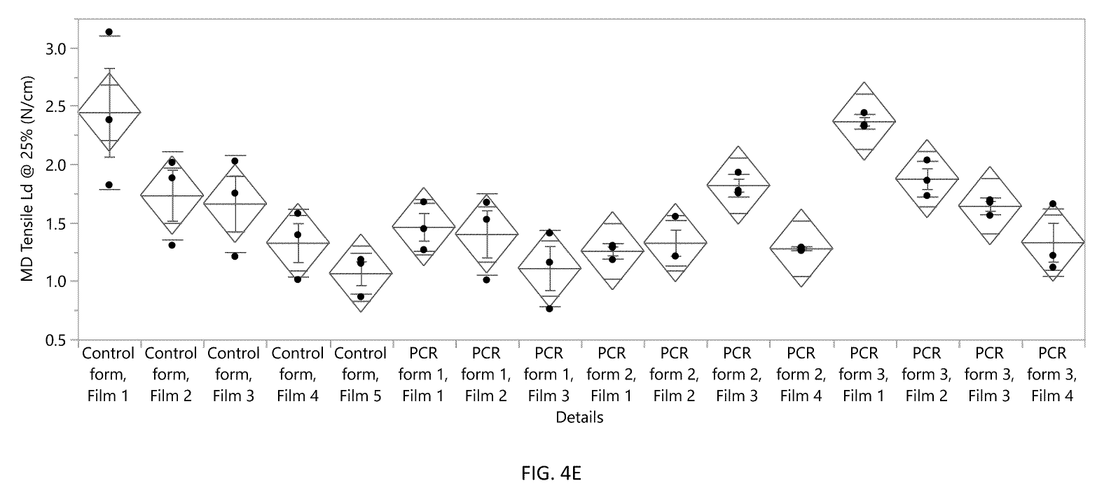

FIGS. 4A-4E illustrate MD tensile load at break and MD tensile elongation at break testing of the films of the present embodiments. For example, as basis weights decrease for each of the control film and PCR forms 1-3, MD tensile load at break trends downward, as shown in FIG. 4A, which suggests that higher basis weight films withstand more MD tensile load for 100% PCR and 80% PCR films. The performance of the 100% PCR and 80% PCR films when subjected to MD tensile loads can suggest that MD tensile load performance is substantially independent of the PCR content of the film.

MD tensile elongation at break percentages for these films can suggest a different outcome. For example, as shown in FIG. 4B, the MD tensile elongation percentage at break is substantially consistent across a PCR film composition, with values remaining substantially unchanged as basis weight decreases. The testing illustrates that.

MD tensile load at 5%, 10%, and 25% break for each of the films are shown in FIGS. 4C, 4D, and 4E respectively. As shown, the MD tensile load remains substantially unchanged at each basis weight across each of the percentages. Moreover, for 100% PCR films (PCR form 1 and PCR form 2), the MD tensile load at break at each of 5%, 10%, and 25% remains substantially flat between a range of about 0.5 and about 2.0, while the MD tensile load at break for the 80% PCR film (PCR form 3) decreases as the basis weight decreases.

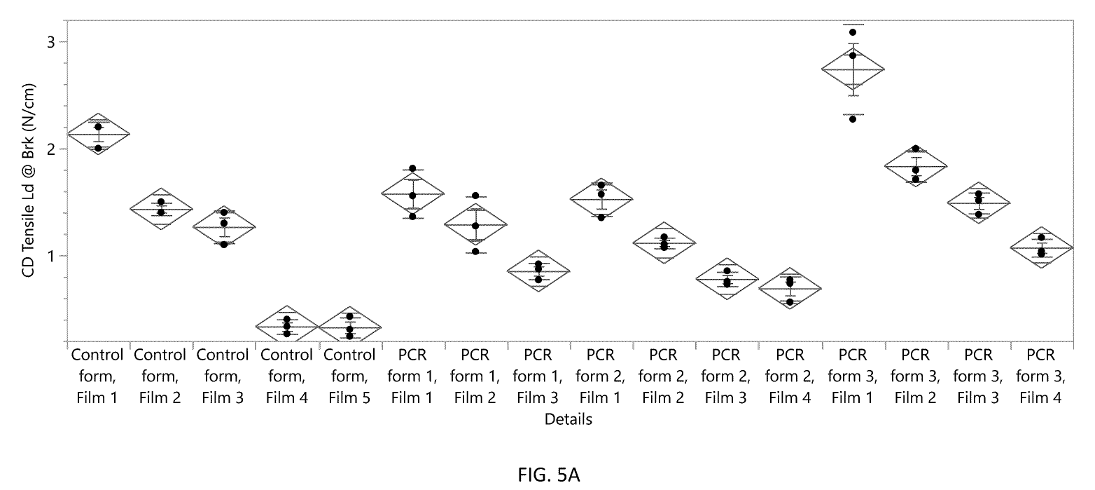

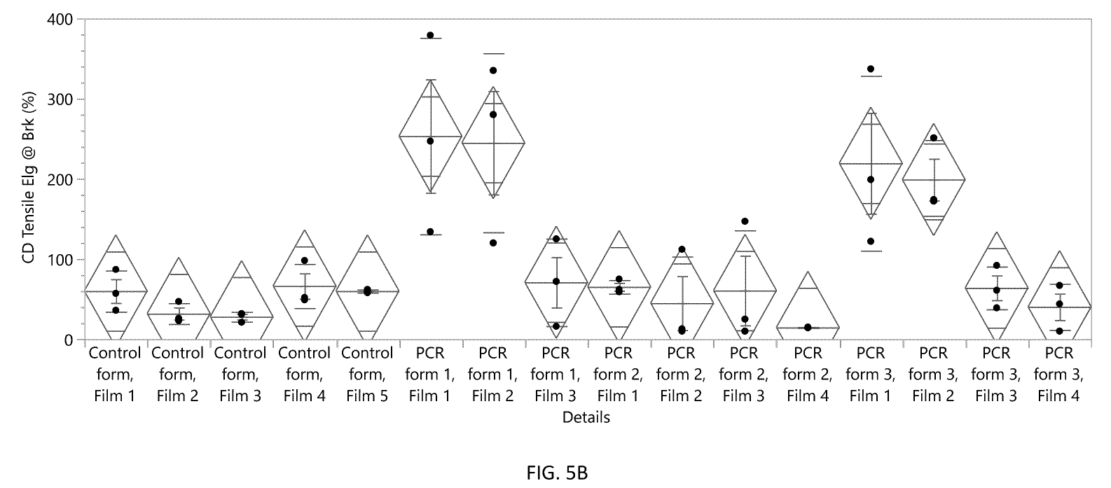

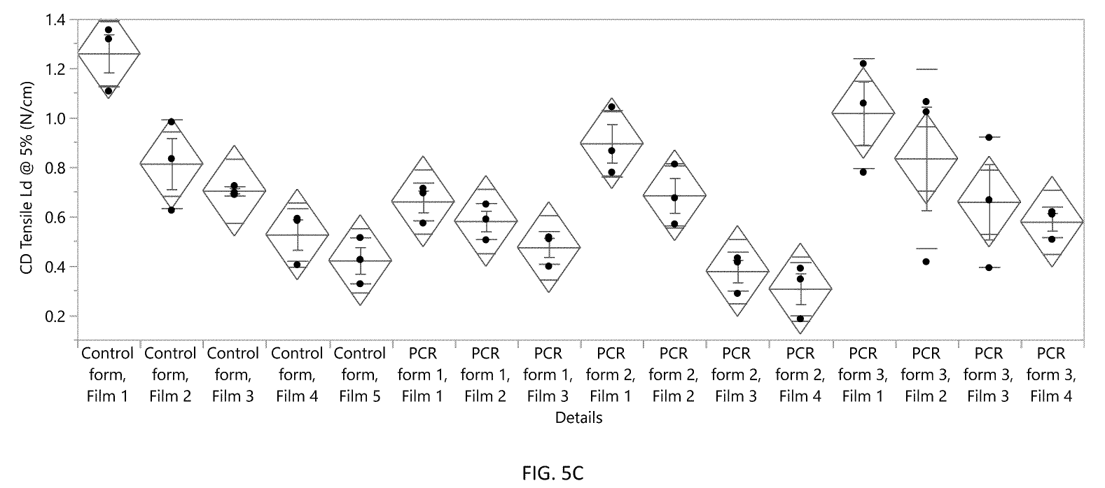

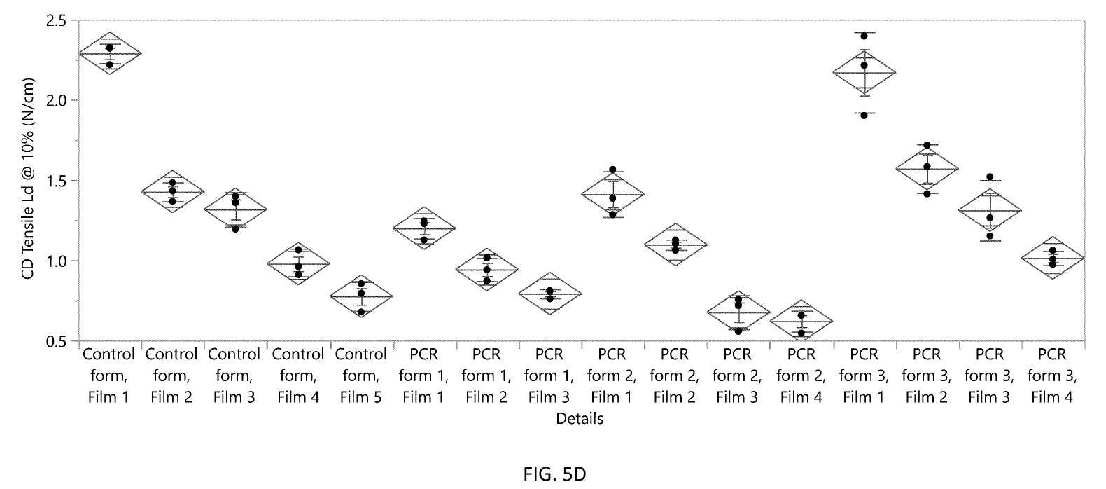

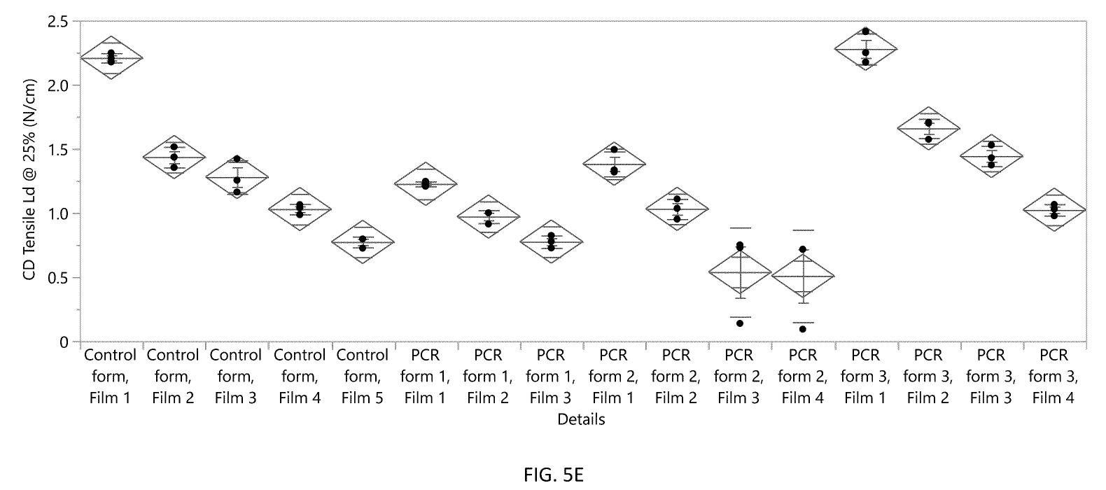

FIGS. 5A-5E illustrate CD tensile load at break and CD tensile elongation at break testing of the films of the present embodiments. For example, as basis weights decrease for each of the control film and PCR forms 1-3, CD tensile load at break tapers downward, as shown in FIG. 5A, which suggests that higher basis weight films withstand more MD tensile load for 100% PCR and 80% PCR films. Specifically, the 80% PCR film shows a significantly higher CD tensile load at break for the 27.5 gsm film. The performance of the 100% PCR and 80% PCR films when subjected to CD tensile loads can suggest that CD tensile load performance is substantially independent of the PCR content of the film.

CD tensile elongation at break percentages for these films can suggest a different outcome. For example, as shown in FIG. 5B, the CD tensile elongation percentage at break is substantially consistent across a PCR film composition at higher basis weights. As basis weight decreases for both the 100% PCR film and the 80% PCR film, the CD tensile elongation at break percentage decreases significantly for the PCR form 1 and the PCR form 3 films at about 15 gsm and lower.

CD tensile load at 5%, 10%, and 25% break for each of the films are shown in FIGS. 5C, 5D, and 5E respectively. As shown, the CD tensile load elongation tapers downward with decreasing basis weights such that PCR films of 100% and 80% are more elongated for films having lower basis weights. As noted above, for embodiments that are used in closure tabs of diapers, films with superior CD stretch results are preferred due to the frequency with which these tabs are exposed to such forces. The testing illustrates that the 100% PCR films offer superior results as compared to 80% PCR films due to more gradual changes in CD tensile load at each of the break percentages as basis weight is decreased. Additionally, PCR form 1 films provide more consistent CD tensile load at each percentage across the range of basis weights, making PCR form 1 films superior to PCR form 2 films.

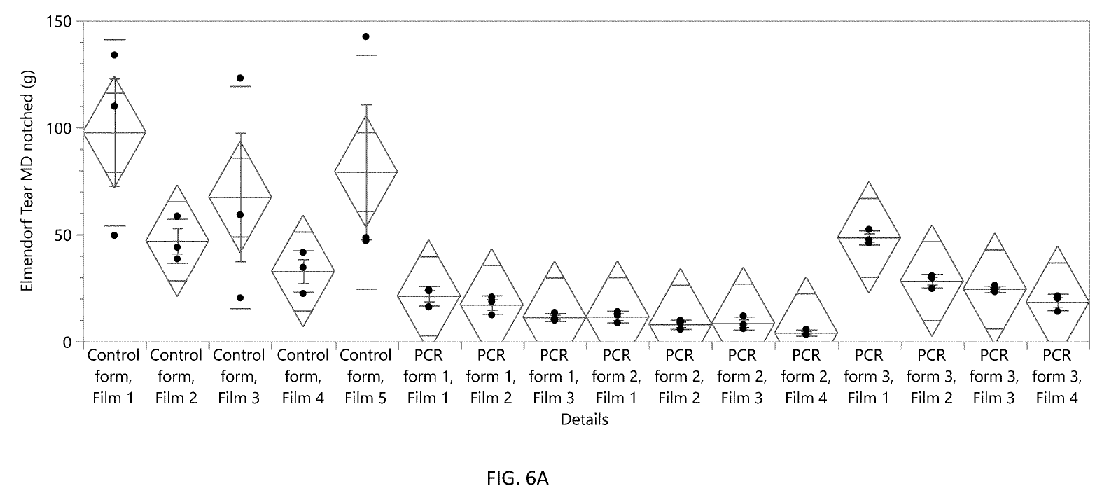

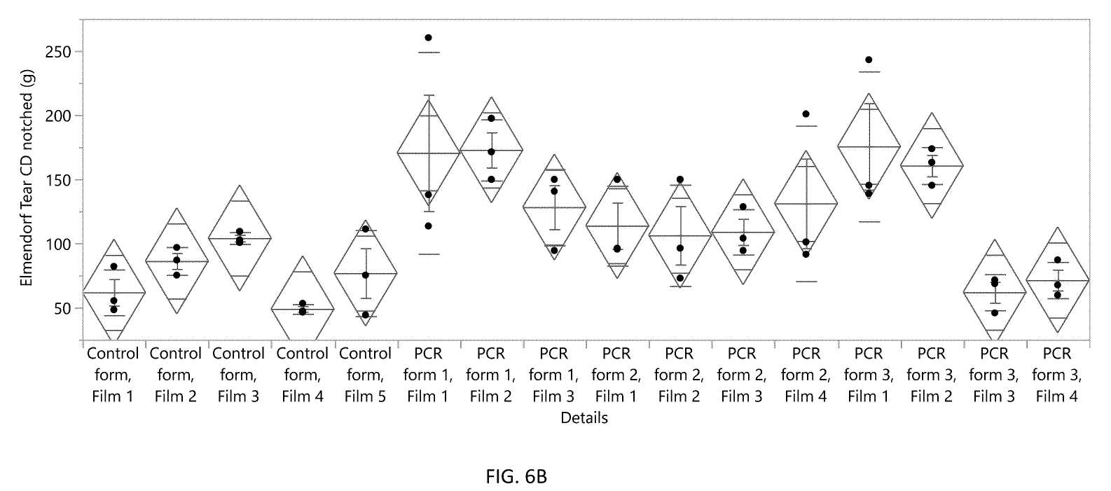

FIGS. 6A-6B illustrate Elmendorf tear strength of each of the films in MD notched and CD notched, respectively. Higher values of the Elmendorf tear strength indicate greater resistance to tearing and are therefore superior to lower values of the Elmendorf tear strength. As shown, higher basis weights of the films tend to result in superior Elmendorf tear strength values. Moreover, a comparison of FIGS. 6A and 6B shows that the CD notched Elmendorf tear strength has higher values than the MD notched Elmendorf tear strength. The testing illustrates that 80% PCR films have higher Elmendorf tear strengths than the 100% PCR films, and that films having higher basis weights have superior tear resistance for use in the films of the present embodiments. In some embodiments, the breathable film can have a machine direction Elmendorf tear strength that is at least three times greater than a machine direction Elmendorf tear strength of a breathable film made with virgin resin that is substantially free from PCR materials under the same process conditions.

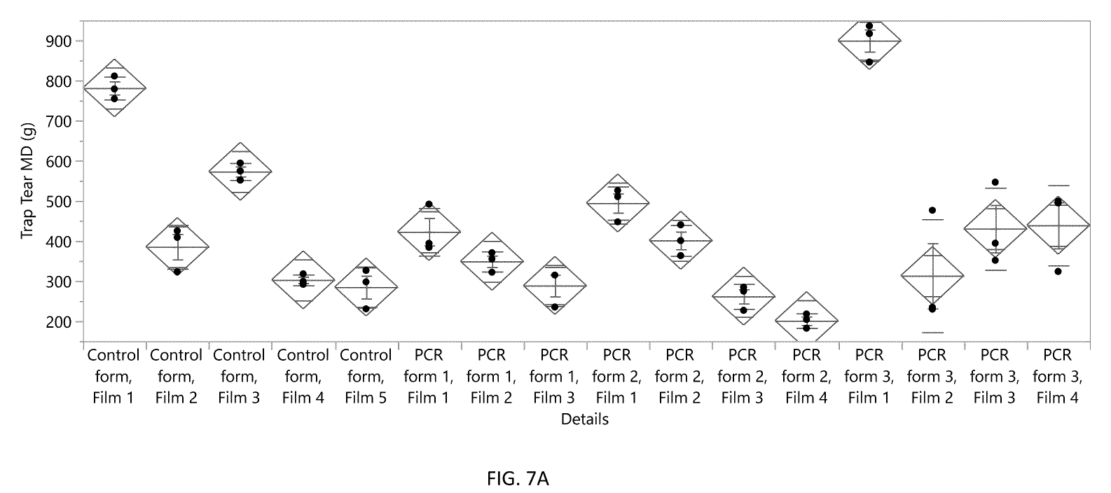

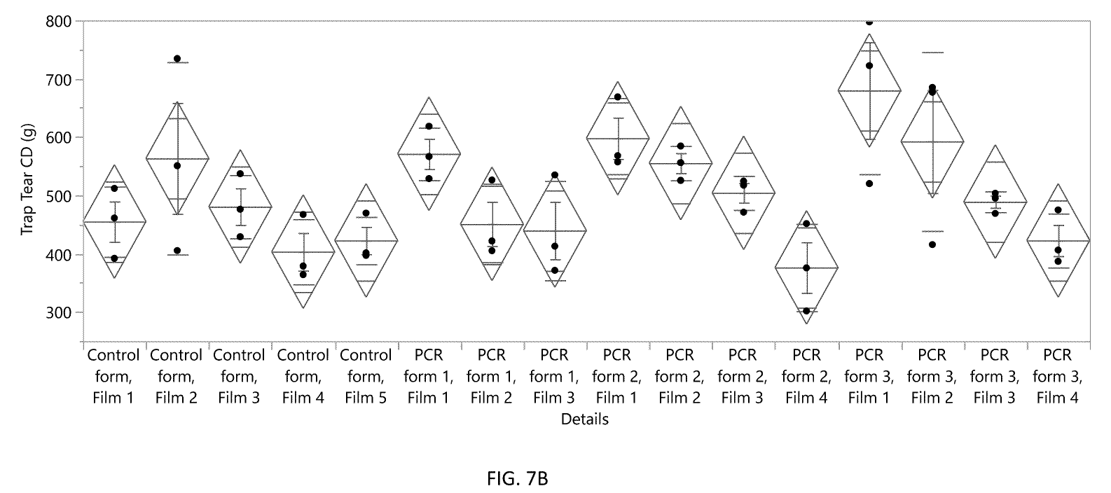

FIGS. 7A-7B illustrate trap tear strength of each of the films in MD notched and CD notched, respectively. Higher values of the trap tear strength indicate greater resistance to tearing and are therefore superior to lower values of the trap tear strength. As shown, higher basis weights of the films tend to result in superior trap tear strength values with thicker films being more resistant to tear. Moreover, a comparison of FIGS. 7A and 7B shows that the CD notched trap tear strength has substantially similar values to the MD notched trap tear strength. The testing illustrates that 80% PCR films have higher trap tear strengths than the 100% PCR films, and that films having higher basis weights have superior tear resistance for use in the films of the present embodiments.

The following numbered clauses include embodiments that are contemplated and non-limiting:
Clause 1. A breathable film, comprising: one or more layers of an extruded resin.
Clause 2. The breathable film of clause 1, any other suitable clause, or any combination of suitable clauses, wherein the extruded resin includes a PCR resin.
Clause 3. The breathable film of clause 2, any other suitable clause, or any combination of suitable clauses, wherein the extruded resin is formed from or more raw ingredients.
Clause 4. The breathable film of clause 3, any other suitable clause, or any combination of suitable clauses, wherein an Elmendorf tear strength of the one or more layers in the cross direction is about three times larger than the Elmendorf tear strength of the one or more layers in the machine direction.
Clause 5. The breathable film of clause 4, any other suitable clause, or any combination of suitable clauses, wherein a trapezoidal tear strength of the one or more layers in the cross direction is about 1.9 times larger than the trapezoidal tear strength of the one or more layers in the machine direction.
Clause 6. The breathable film of clause 5, any other suitable clause, or any combination of suitable clauses, wherein the extruded resin comprises about 100% PCR resin.
Clause 7. The breathable film of clause 5, any other suitable clause, or any combination of suitable clauses, wherein the extruded resin further comprises a total filler of about 42 wt % and a total polymer phase of about 58 wt % relative to a total weight of the film.
Clause 8. The breathable film of clause 5, any other suitable clause, or any combination of suitable clauses, wherein a basis weight of the one or more layers is approximately in a range of about 5 gsm to about 20 gsm.
Clause 9. The breathable film of clause 5, any other suitable clause, or any combination of suitable clauses, wherein the Elmendorf tear strength of the one or more layers in the cross direction is approximately in a range from about 25 g to about 250 g.
Clause 10. The breathable film of clause 5, any other suitable clause, or any combination of suitable clauses, wherein the trapezoidal tear strength of the one or more layers in the cross direction is approximately in a range from about 300 g to about 800 g.
Clause 11. The breathable film of clause 5, any other suitable clause, or any combination of suitable clauses, wherein the one or more layers comprise about 80% PCR resin.
Clause 12. The breathable film of clause 5, any other suitable clause, or any combination of suitable clauses, wherein the 80% PCR resin includes a total filler of about 39 wt % and a total polymer phase of about 61 wt % relative to a total weight of the film.
Clause 13. The breathable film of clause 5, any other suitable clause, or any combination of suitable clauses, wherein the resin further comprises an LLDPE.
Clause 14. The breathable film of clause 13, any other suitable clause, or any combination of suitable clauses, wherein the LLDPE is approximately in a range from about 10 wt % to about 20 wt % relative to a total weight of the film.
Clause 15. The breathable film of clause 5, any other suitable clause, or any combination of suitable clauses, wherein the one or more raw ingredients further comprises one or more of a polyethylene resin or a PCR compound.
Clause 16. The breathable film of clause 15, any other suitable clause, or any combination of suitable clauses, wherein the polyethylene resin comprises about 72% FL 500 CaCO₃, about 21.85% Dow 2036.01G LLDPE, about 6% TiO₂ and about 0.15% of an anti-oxidant package.
Clause 17. The breathable film of clause 15, any other suitable clause, or any combination of suitable clauses, wherein the PCR Compound comprises about 70% FL 500 CaCO₃, about 29.8% Ecowise LLDPE and about 0.2% of an anti-oxidant package.
Clause 18. The breathable film of clause 5, any other suitable clause, or any combination of suitable clauses, wherein the one or more layers further comprises a plurality of layers.
Clause 19. The breathable film of clause 18, any other suitable clause, or any combination of suitable clauses, wherein each of the plurality of layers is formed substantially from a PCR resin.
Clause 20. A method of making a breathable film, comprising: combining one or more raw ingredients to make a resin.
Clause 21. The method of clause 20, any other suitable clause, or any combination of suitable clauses, wherein the raw ingredients including a PCR compound composed of an amount of approximately about 80% PCR resin to about 100% PCR resin by weight.
Clause 22. The method of clause 21, any other suitable clause, or any combination of suitable clauses, further comprising passing the resin into an extruder to extrude a precursor film therefrom.
Clause 23. The method of clause 22, any other suitable clause, or any combination of suitable clauses, further comprising stretching the precursor film through a CDI unit to stretch the precursor film in the CD direction and form the breathable film.
Clause 24. The method of clause 23, any other suitable clause, or any combination of suitable clauses, wherein an Elmendorf tear strength of the breathable film in the cross direction is about three times larger than the Elmendorf tear strength of the one or more layers in the machine direction.
Clause 25. The method of clause 24, any other suitable clause, or any combination of suitable clauses, wherein a trapezoidal tear strength of the breathable film in the cross direction is about 1.9 times larger than the trapezoidal tear strength of the one or more layers in the machine direction.
Clause 26. The method of clause 25, any other suitable clause, or any combination of suitable clauses, wherein combining one or more raw ingredients further comprises compounding the one or more raw ingredients to make the resin.
Clause 27. The method of clause 25, any other suitable clause, or any combination of suitable clauses, wherein the one or more raw ingredients further comprises one or more of a polyethelene resin or a PCR compound.
Clause 28. The method of clause 27, any other suitable clause, or any combination of suitable clauses, wherein the polyethylene resin comprises about 72% FL 500 CaCO₃, about 21.85% Dow 2036.01G LLDPE, about 6% TiO₂ and about 0.15% of an anti-oxidant package.
Clause 29. The method of clause 27, any other suitable clause, or any combination of suitable clauses, wherein the PCR Compound comprising about 70% FL 500 CaCO₃, about 29.8% Ecowise LLDPE and about 0.2% of an anti-oxidant package.
Clause 30. The method of clause 25, any other suitable clause, or any combination of suitable clauses, further comprising adjusting a line speed of the extruder to change a basis weight of the breathable film.
Clause 31. The method of clause 25, any other suitable clause, or any combination of suitable clauses, wherein the resin further comprises an LLDPE.
Clause 32. The method of clause 31, any other suitable clause, or any combination of suitable clauses, wherein the LLDPE is approximately in a range from about 10 wt % to about 20 wt % relative to a total weight of the film.
Clause 33. The method of clause 25, any other suitable clause, or any combination of suitable clauses, wherein the LLDPE is EM 3518 or Ecowise.
Clause 34. A breathable film, comprising: at least one layer composed of post-consumer recycled (PCR) materials.
Clause 35. The breathable film of clause 34, any other suitable clause, or any combination of suitable clauses, wherein the at least one layer is in an amount of approximately about 80% PCR resin to about 100% PCR resin by weight to the at least one layer.
Clause 36. The breathable film of clause 35, any other suitable clause, or any combination of suitable clauses, wherein the breathable film has a cross direction tensile strength that is decreased not more than 20% as compared to a cross direction tensile strength of a breathable film made with virgin resin that is substantially free from PCR materials under the same process conditions.
Clause 37. The breathable film of clause 36, any other suitable clause, or any combination of suitable clauses, wherein the breathable film has a machine direction tensile strength that is decreased not more than 20% as compared to a machine direction tensile strength of a breathable film made with virgin resin that is substantially free from PCR materials under the same process conditions.
Clause 38. A breathable film, comprising: at least one layer composed of post-consumer recycled (PCR) materials in an amount of approximately about 80% PCR resin to about 100% PCR resin by weight.
Clause 39. The breathable film of clause 38, any other suitable clause, or any combination of suitable clauses, wherein the breathable film has a cross direction Elmendorf tear strength that is at least two times greater than a cross direction Elmendorf tear strength of a breathable film made with virgin resin that is substantially free from PCR materials under the same process conditions.
Clause 40. The breathable film of clause 39, any other suitable clause, or any combination of suitable clauses, wherein the breathable film has a machine direction Elmendorf tear strength that is at least three times greater than a machine direction Elmendorf tear strength of a breathable film made with virgin resin that is substantially free from PCR materials under the same process conditions.
Clause 41. The breathable film of clause 39, any other suitable clause, or any combination of suitable clauses, wherein the breathable film has a cross direction trapezoidal tear strength that is about 1.5 times to about 2.5 times greater than a cross direction trapezoidal tear strength of a breathable film made with virgin resin that is substantially free from PCR materials under the same process conditions.
Clause 42. The breathable film of clause 5, any other suitable clause, or any combination of suitable clauses, wherein a mocon value of the one or more layers is approximately in a range from about 1,000 g/m²/day to about 20,000 g/m²/day.

1. A breathable film, comprising:
one or more layers of an extruded resin, the extruded resin including a PCR resin formed from or more raw ingredients;
wherein an Elmendorf tear strength of the one or more layers in the cross direction is about three times larger than the Elmendorf tear strength of the one or more layers in the machine direction; and
wherein a trapezoidal tear strength of the one or more layers in the cross direction is about 1.9 times larger than the trapezoidal tear strength of the one or more layers in the machine direction.

2. The breathable film of claim 1, wherein the extruded resin comprises about 100% PCR resin.

3. The breathable film of claim 2, wherein the extruded resin further comprises a total filler of about 42 wt % and a total polymer phase of about 58 wt % relative to a total weight of the film.

4. The breathable film of claim 1, wherein a basis weight of the one or more layers is approximately in a range of about 5 gsm to about 20 gsm.

5. The breathable film of claim 1, wherein the Elmendorf tear strength of the one or more layers in the cross direction is approximately in a range from about 25 g to about 250 g.

6. The breathable film of claim 1, wherein the trapezoidal tear strength of the one or more layers in the cross direction is approximately in a range from about 300 g to about 800 g.

7. The breathable film of claim 1, wherein a mocon value of the one or more layers is approximately in a range from about 1,000 g/m²/day to about 20,000 g/m²/day.

8. The breathable film of claim 1, wherein the one or more layers comprise about 80% PCR resin.

9. The breathable film of claim 8, wherein the 80% PCR resin includes a total filler of about 39 wt % and a total polymer phase of about 61 wt % relative to a total weight of the film.

10. The breathable film of claim 1, wherein the resin further comprises an LLDPE approximately in a range from about 10 wt % to about 20 wt % relative to a total weight of the film.

11. The breathable film of claim 1, wherein the one or more raw ingredients further comprises one or more of a polyethylene resin or a PCR compound, the polyethylene resin comprising about 72% FL 500 CaCO₃, about 21.85% Dow 2036.01G LLDPE, about 6% TiO₂ and about 0.15% of an anti-oxidant package, and the PCR Compound comprising about 70% FL 500 CaCO₃, about 29.8% Ecowise LLDPE and about 0.2% of an anti-oxidant package.

12. The breathable film of claim 1, wherein the one or more layers further comprises a plurality of layers, each of the plurality of layers being formed substantially from a PCR resin.

13. A method of making a breathable film, the method comprising:
combining one or more raw ingredients to make a resin, the raw ingredients including a PCR compound composed of an amount of approximately about 80% PCR resin to about 100% PCR resin by weight;
passing the resin into an extruder to extrude a precursor film therefrom; and
stretching the precursor film through a CDI unit to stretch the precursor film in the CD direction and form the breathable film,
wherein an Elmendorf tear strength of the breathable film in the cross direction is about three times larger than the Elmendorf tear strength of the one or more layers in the machine direction; and
wherein a trapezoidal tear strength of the breathable film in the cross direction is about 1.9 times larger than the trapezoidal tear strength of the one or more layers in the machine direction.

14. The method of claim 13, wherein combining one or more raw ingredients further comprises compounding the one or more raw ingredients to make the resin.

15. The method of claim 13, wherein the one or more raw ingredients further comprises one or more of a polyethelene resin or a PCR compound, the polyethylene resin comprising about 72% FL 500 CaCO₃, about 21.85% Dow 2036.01G LLDPE, about 6% TiO₂ and about 0.15% of an anti-oxidant package, and the PCR Compound comprising about 70% FL 500 CaCO₃, about 29.8% Ecowise LLDPE and about 0.2% of an anti-oxidant package.

16. The method of claim 13, further comprising adjusting a line speed of the extruder to change a basis weight of the breathable film.

17. The method of claim 13, wherein the resin further comprises an LLDPE approximately in a range from about 10 wt % to about 20 wt % relative to a total weight of the film.

18. The method of claim 17, wherein the LLDPE is EM 3518 or Ecowise.

19. A breathable film, comprising:
at least one layer composed of post-consumer recycled (PCR) materials in an amount of approximately about 80% PCR resin to about 100% PCR resin by weight to the at least one layer,
wherein the breathable film has a cross direction tensile strength that is decreased not more than 20% as compared to a cross direction tensile strength of a breathable film made with virgin resin that is substantially free from PCR materials under the same process conditions.

20. The breathable film of claim 19, wherein the breathable film has a machine direction tensile strength that is decreased not more than 20% as compared to a machine direction tensile strength of a breathable film made with virgin resin that is substantially free from PCR materials under the same process conditions.

21. A breathable film, comprising:
at least one layer composed of post-consumer recycled (PCR) materials in an amount of approximately about 80% PCR resin to about 100% PCR resin by weight,
wherein the breathable film has a cross direction Elmendorf tear strength that is at least two times greater than a cross direction Elmendorf tear strength of a breathable film made with virgin resin that is substantially free from PCR materials under the same process conditions.

22. The breathable film of claim 21, wherein the breathable film has a machine direction Elmendorf tear strength that is at least three times greater than a machine direction Elmendorf tear strength of a breathable film made with virgin resin that is substantially free from PCR materials under the same process conditions.

23. The method of claim 21, wherein the breathable film has a cross direction trapezoidal tear strength that is about 1.5 times to about 2.5 times greater than a cross direction trapezoidal tear strength of a breathable film made with virgin resin that is substantially free from PCR materials under the same process conditions.
